(19) United States
(12) Patent Application Publication
(10) Pub. No.: US 2004/0065654 A1
(43) Pub. Date: Apr. 8, 2004

(54) Oven with cavity having turntable and heater

(76) Inventors: Gavin John Coleman, Bromsgrove (GB); Karen Sarah Simpson, Worcestershire (GB)

Correspondence Address: Ira S Dorman, Suite 200, 330 Roberts Street, East Hartford, CT, 06108, US

(21) Appl. No.: 10/416,197

(22) PCT Filed: Nov. 6, 2001
(86) PCT No.: PCT/GB01/04921

(30) Foreign Application Priority Data
Nov. 10, 2000 (GB) 00274647

(51) Int. Cl. A21B 1/00

(52) U.S. Cl. 219/391

(57) ABSTRACT

An oven (2), such as a microwave oven comprises an oven cavity (6) having therein a rotatable turntable (8) for supporting one or more items (30, 32), such as food, to be heated. A radiant electric heater (10) is located above the turntable and overlies at least a major part of a substantially semi-circular portion (12) of the turntable (8), including a peripheral region (14) thereof and a central, or near central, region (16) thereof. The heater (10) incorporates at least one heating element (22) adapted and arranged (26, 28) to provide a higher power density over the peripheral region (14) of the turntable (8) than over the central, or near central, region (16) of the turntable (8).

The present invention relates to an oven comprising an oven cavity provided with a turntable and further comprising a radiant electric heater.

Ovens such as microwave ovens are known, comprising an oven cavity having therein a rotatable turntable for supporting food to be heated. It is known to locate a radiant electric heater above the turntable for grilling, browning or baking the food on the turntable. Such a radiant heater is known to be located over a substantially semi-circular portion of the turntable, such that food on the rotating turntable passes under the heater.

A problem with such an arrangement is that food located near a peripheral region of the rotating turntable is heated to a lesser degree than food located at, or near, a central region of the rotating turntable. This results in uneven cooking of the food.

It is an object of the present invention to overcome or minimise this problem.

According to the present invention there is provided an oven comprising an oven cavity provided therein with a rotatable turntable for supporting one or more items to be heated, and a radiant electric heater being located above the turntable and overlying at least a major part of a substantially semi-circular portion of the turntable, including a peripheral region thereof and a central, or near central, region thereof, wherein the heater incorporates at least one heating element adapted and arranged to provide a higher power density over the peripheral region of the turntable than over the central, or near central, region of the turntable.

The at least one heating element may be adapted and arranged whereby the power density provided over the peripheral region of the turntable is from 110 to 140 percent, and preferably from 120 to 130 percent, of the power density provided over the central, or near central, region of the turntable.

The power density provided by the at least one heating element over the peripheral region of the turntable may be of the order of 5.5 watts per square centimetre and the power density provided by the at least one heating element over the central, or near central, region of the turntable may be of the order of 4.25 watts per square centimetre.

The at least one heating element may comprise spaced apart turns, such as meandering turns, of elongate electrical conductor material having adjacent turns more closely spaced where they overlie the peripheral region of the turntable than where they overlie the central, or near central, region of the turntable.

The at least one heating element may be of wire or ribbon form and may be supported on a base layer of electrical insulation material, such as microporous thermal and electrical insulation material. The base layer of insulation material may be provided in a dish-like support, such as of metal.

The heater may be of generally rectangular shape, which may be non-square.

The heater may be located in the oven so as to be as remote as possible from a door of the oven.

As a result of the present invention, an item, such as a food item, supported on the rotatable turntable for heating by the radiant electric heater, is heated to a substantially similar degree regardless of whether it is located at a peripheral or central region of the turntable. An item overlapping both regions of the turntable is substantially uniformly heated throughout. The higher power density of heating provided over the peripheral region of the turntable compensates for the food at the peripheral region of the turntable spending more time out of the zone heated by the heater than food at, or near, the central region of the turntable.

For a better understanding of the invention and to show more clearly how it may be carried into effect, reference will now be made, by way of example, to the accompanying drawings in which:

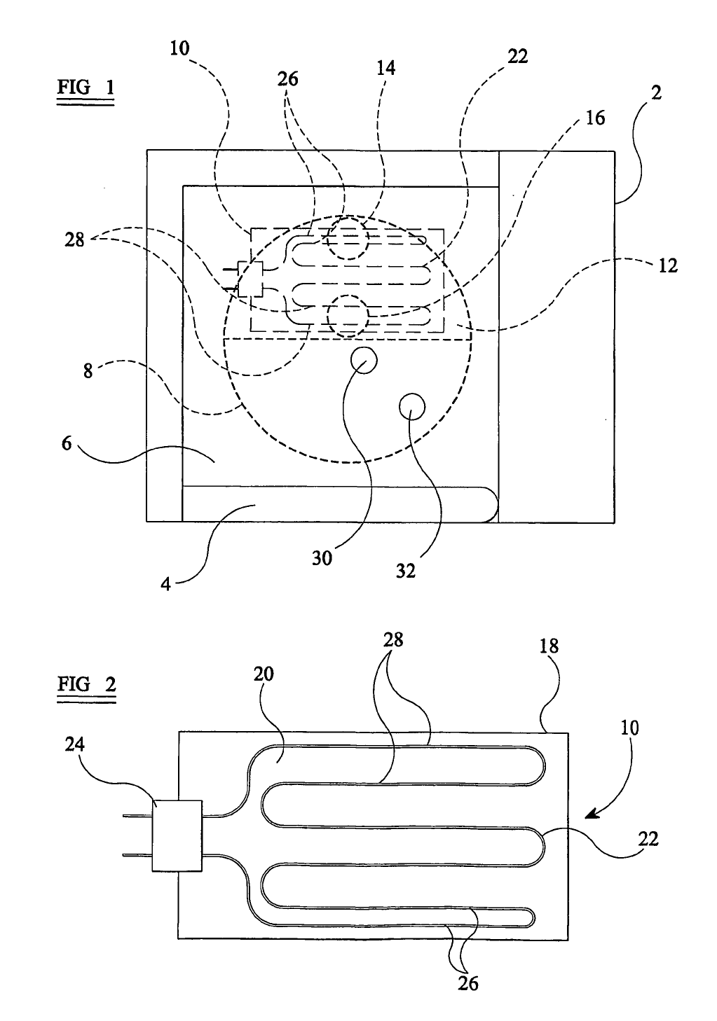

FIG. 1 is a top plan view representation of one embodiment of an oven according to the present invention; and

FIG. 2 is a front plan view of a radiant electric heater forming part of the oven of FIG. 1.

Referring to FIG. 1, an oven 2, such as a microwave oven, has a door 4 and is provided with an oven cavity 6. A well known form of turntable 8 is provided in the oven cavity 6 and arranged for rotation by well known means (not shown). The turntable 8 is intended for supporting one or more food items to be heated.

A radiant electric heater 10 at least having a heated area of non-square rectangular shape, as shown in FIG. 2, is located at the top of the oven cavity 6, above the turntable 8 and overlying at least a major part of a substantially semi-circular portion 12 of the turntable 8, including a peripheral region 14 thereof and a central, or near central, region 16 thereof. The heater 10 is located as remotely as possible from the door 4 of the oven 2.

The heater 10 comprises a metal dish-like support 18 containing a base layer 20 of insulation material, such as well known microporous thermal and electrical insulation material. An electrical heating element 22, comprising spaced apart meandering turns of elongate conductor material, is supported on the base layer 20 of insulation material and electrically connected to a terminal block 24 for energising from a power supply (not shown).

The heating element 22 can comprise any of the well known forms of element material, such as wire or ribbon forms. In particular, the heating element 22 comprises a corrugated ribbon supported edgewise on the base layer 20 of insulation material.

The heating element 22 is arranged such that it provides a higher power density over the peripheral region 14 of the turntable 8 than over the central, or near central, region 16 of the turntable 8. This is achieved by providing adjacent turns 26 of the heating element 22, overlying the peripheral region 14 of the turntable 8, which are more closely spaced apart than corresponding adjacent turns 28 which overlie the central, or near central, region 16 of the turntable 8.

By way of example, the power density provided by the more closely spaced adjacent turns 26 of the heating element 22 is of the order of 5.5 watts per square centimetre, whilst the corresponding power density provided by the more widely spaced turns 28 of the heating element 22 is of the order of 4.25 watts per square centimetre.

As a result of the invention, food items 30 and 32, located respectively at central and peripheral regions of the turntable 8, are cooked to a substantially similar degree when passed beneath the heater 10. The higher power density of heating provided over the peripheral region of the turntable 8 compensates for the food item 32 at the peripheral region of the turntable 8 spending more time out of the influence, or at least the full influence, of the heater 10 than the food item 30 at the central region of the turntable 8. A food item overlapping both the central and the peripheral regions of the turntable 8 will be substantially uniformly cooked by the heater 10.

1. An oven comprising an oven cavity (6) provided therein with a rotatable turntable (8) for supporting one or more items to be heated, and a radiant electric heater (10) located above the turntable and overlying at least a major part of a substantially semi-circular portion (12) of the turntable, including a peripheral region (14) thereof and a central, or near central, region (16) thereof, characterised in that the heater (10) incorporates at least one heating element (22) adapted and arranged to provide a higher power density over the peripheral region (14) of the turntable than over the central, or near central, region (16) of the turntable.

2. An oven as claimed in claim 1, characterised in that the at least one heating element (22) is adapted and arranged whereby the power density provided over the peripheral region (14) of the turntable (8) is from 110 to 140 percent, preferably from 120 to 130 percent, of the power density provided over the central, or near central, region (16) of the turntable.

3. An oven as claimed in claim 1 or 2, characterised in that the power density provided by the at least one heating element (22) over the peripheral region (14) of the turntable (8) is of the order of 5.5 watts per square centimetre and the power density provided by the at least one heating element over the central, or near central, region (16) of the turntable is of the order of 4.25 watts per square centimetre.

4. An oven as claimed in any preceding claim, characterised in that the at least one heating element (22) comprises spaced apart turns of elongate electrical conductor material having adjacent turns more closely spaced where they overlie the peripheral region (14) of the turntable (8) than where they overlie the central, or near central, region (16) of the turntable.

5. An oven as claimed in claim 4, characterised in that the spaced apart turns of elongate electrical conductor material comprise meandering turns.

6. An oven as claimed in claim 4 or 5, characterised in that the at least one heating element (22) is of wire or ribbon form.

7. An oven as claimed in claim 6, characterised in that the at least one heating element (22) is supported on a base layer (20) of electrical insulation material such as microporous thermal and electrical insulation material.

8. An oven as claimed in claim 7, characterised in that the base layer (20) of insulation material is provided in a dish-like support (18), for example of metal.

9. An oven as claimed in any preceding claim, characterised in that the heater (10) is of generally rectangular shape, for example of non-square rectangular shape.

10. An oven as claimed in any preceding claim, characterised in that the heater (10) is located in the oven so as to be as remote as possible from a door (4) of the oven.
